(19) United States
(12) Patent Application Publication
(10) Pub. No.: US 2010/0064231 A1
(43) Pub. Date: Mar. 11, 2010

(54) System for Creating Associations Between Elements of a Message Application

(76) Inventor: Puneet K. Gupta, Newark, CA (US)

Correspondence Address: CENTRAL COAST PATENT AGENCY, INC, 3 HANGAR WAY SUITE D, WATSONVILLE, CA, 95076, US

(21) Appl. No.: 12/208,902

(22) Filed: Sep. 11, 2008

(51) Int. Cl. G06F 3/00

(52) U.S. Cl. 715/748

(57) ABSTRACT

A messaging application includes a user interface executable from a digital media on a computing system onboard or accessible to a computing appliance, the user interface enabling display and access to one or more message folders, a list of contacts, a calendar, and a message generation template, and a word tagging utility installed to and executable from the digital media and made accessible through the user interface. The application is characterized in that the word tagging utility is operable to tag functional elements of the message application to create associations between the tagged elements, the associations recognized by the messaging application in the performance of tasks involving the elements.

### CROSS-REFERENCE TO RELATED APPLICATIONS

NA

### BACKGROUND OF THE INVENTION

1. Field of the Invention

The present invention is in the field of network communications, particularly electronic messaging systems, and pertains in some aspects to enhanced application interfaces for interacting within a messaging system using created associations between specific message application elements.

2. Discussion of the state of the art:

Electronic messaging is well known in the art and there are many messaging programs available for sending and receiving electronic messages such as email, for example, over a data network. Email messages are a good example of asynchronous electronic messaging although there are other kinds of messaging systems such as instant messaging (IM), simple message service (SMS), media message service (MMS), bulletin board posts, and so on.

In email messaging systems there are Internet-based email systems that run over instant message application protocol (IMAP) and desktop-based programs that use post office protocol (POP) and simple message transfer protocol (SMTP) for sending and receiving email. Voice and video mail are popular extensions of text email programs. IMAP and POP systems may be integrated such that a desktop-based email program can be configured to receive IMAP messages from a message server.

The main difference between the IMAP and POP systems is that with IMAP a user logs into a server and reviews messages at the server via an interface also provided by the server. Data storage is at the server as well is all of the message folders, etc. The user stores no information locally. With POP, the user has a desktop email application such as Exchange™, or Outlook™, both popular programs from Microsoft™. The user uses the desktop application to contact an email server and downloads messages from the server to the desktop where they are subsequently stored. Therefore, POP users have a personal file or folder known as a .PST file that may contain all of the data used by and accessible to the desktop email application including all contact data and calendar data in some cases.

Most state-of-art desktop email applications combine multiple functionalities with standard email capabilities. One good example of this is Microsoft's Outlook™. Outlook provides a calendar, an alert service, task scheduling, contact management, a search interface, and a summary page showing calendar items, scheduled tasks, and summary information such as the number of unread mails and message folder totals.

Many email applications like Outlook™ allow a user to create folders for special incoming messages where such users desire to segregate specific messages based on subject or some other criteria. When a message arrives at an inbox of a user, only then will that user be able to act upon the message by highlighting and selecting the message for processing. Like many functional data processing applications, email messages in Outlook™ may be marked, flagged, deleted, moved, duplicated, archived, saved in different file formats.

With all of the organizational capabilities and tools available in a state-of-art desktop email application, there is not much automation and only very limited routing capability available at the receiving end system or appliance. Filters can be set up to filter incoming mail for spam or unwanted messages. Security encryption can be set up to compress and encrypt messages and attachments. These additional features are often provided through plug-in modules compatible to the desktop application.

The inventors have observed that users of state-of-art, multi-task capable applications like MS Outlook™ typically have many folders that they have created to hold messages from specific users or to hold messages that fall under some specific category. However, messages in those folders are deposited manually by the user based on user disposition. Ad-Hoc management of so many folders becomes difficult and time consuming. Many incoming messages that had not the highest priority at the time of arrival tend to disappear in these folders and may be neglected or forgotten for a time or may not be answered at all.

The only typical automations of an email system are evident in task scheduling, state alerting, and calendar-related reminders. There is not much management capability for managing the messages themselves with the exception of standard messaging commands like reply, forward, save, save as, delete, sort, compact, search, send to, mark unmark, and move to.

What is clearly needed is a method and system for operating email or other electronic message applications relative to current communication patterns and message folder topographies by creating and implementing associations between application elements. Such a system could also integrate various email application features with automated processing made available through an electronic messaging interface.

### SUMMARY OF THE INVENTION

A problem stated above is that with all of the organizational capabilities and tools available in a state-of-art desktop email application, there is not much automation and only very limited routing capability available at the receiving end system or appliance. Many messaging application utilize message folders to store messages. One byproduct of such capability is the abundance of message folders in one interface. Ad-Hoc management of so many folders becomes difficult and time consuming. Many incoming messages that had not the highest priority at the time of arrival tend to disappear in these folders and may be neglected or forgotten for a time or may not be answered at all.

The inventors therefore considered functional elements of a messaging system, looking for elements that exhibit potential cross relationships that could potentially be harnessed to provide better management of messages and associated data but in a manner that would not be time consuming for a user.

Every electronic messaging interface is characterized by one or more inbox message folders that contain incoming messages from users characterized as known contacts or unknown individuals. Most interfaces employ contact lists and a variety of folder options to organize received messages for archiving after they are read.

The present inventor realized in an inventive moment that if, at the point of access or download, electronic message could be caused to be routed to content relevant folders wherefrom they may be easily searched and located, significant improvement in organization might result. The inventor therefore constructed a unique tagging and message routing system for electronic messaging applications that allowed messages to be routed to appropriate folders based on created associations between folders and messages to be stored therein. The tagging system may also be used to create associations between other messaging application elements thereby facilitating improved location and utilization of other data types like calendar data and task performance data significant improvement in organizational capability and efficiency resulted with no significant learning required of the user to operate the system.

Accordingly, in one embodiment of the invention a messaging application is provided comprising a user interface executable from a digital media on a computing system onboard or accessible to a computing appliance, the user interface enabling display and access to one or more message folders, a list of contacts, a calendar, and a message generation template, and a word tagging utility installed to and executable from the digital media and made accessible through the user interface. The application is characterized in that the word tagging utility is operable to tag functional elements of the message application to create associations between the tagged elements, the associations recognized by the messaging application in the performance of tasks involving the elements.

In one embodiment, the user interface is an email interface and the computing system is a memory drive integral to the computing appliance. In another embodiment the user interface is an email interface and the computing system is a server with a digital medium accessible to the computing appliance over a data network. In a variation of this embodiment the data network is the Internet network.

In one embodiment the functional elements subject to tagging include at least message folders and contacts. In an extension to this embodiment the functional elements subject to tagging further include scheduled appointments and related tasks pending.

According to one aspect of the invention, a tagging system comprising a tagging utility executable from a digital storage system onboard or accessible to a computing appliance, the tagging utility having a user data input interface and a target selection interface; a database for storing tag words and for mapping associations between tagged elements; and an application program interface to a messaging application. The tagging system is characterized in that the targets subject to tagging are functional elements stored by or made part of the messaging application and the act of tagging such elements causes the application to, based on the tag associations created, perform specific tasks relative to the tagged elements and associations created.

In one embodiment the messaging application is an email application and the storage system is a memory drive integral to the computing appliance. In another embodiment the messaging application is an email application and the storage system is a server with a digital medium accessible to the computing appliance over a data network.

In one aspect of the tagging system one of the specific tasks is routing email messages based on tag associations between from identities and message folders.

According to another aspect of the invention a method is provided for routing electronic messages comprising the steps: (a) using a tagging utility, tagging one or more individual contacts with one or more tags; (b) tagging one or more existing or created message folders based in part on the tagging operation of step (a) defining associations between the contacts of step (a) and the message folders by one or more common tags; (c) receiving an electronic message from one or more of the contacts the message including a subject line and a from identity; and (d) routing the electronic message to the one or more message folders based on the associations defined by the tagging operation.

In one aspect of the method the messages are email messages and the message sorting is performed by an email application. In a preferred aspect in step (a) the tagging utility is executable through a control on a toolbar of a messaging application interface.

In one aspect of the method at step (d) the routing is performed after the message is read by a user, the final destination for routing dependent upon user acceptance or rejection of a folder recommendation. In another aspect at step (d) the routing is performed immediately after a message has arrived and before it is accessed by a user.

In one aspect steps (a) and (b) are performed automatically a first time by crawling through a personal folder containing one or more folders and a list of contacts.

According to a further aspect of the invention a method is provided for routing electronic messages comprising the steps: (a) using a tagging utility, tagging one or more existing or created message folders defining associations between messaging contacts of a contact list and the message folders; (b) receiving an electronic message from one or more of the contacts the message including a subject line and a from identity; and (c) routing the electronic message to the one or more message folders based on parsing the subject line of the message and matching that to the tags for one or more message folders.

In one aspect of this method in step (b) one or more parts of the identity of the message originator are used to define the association to an existing or created folder also tagged with one or more parts of the identity.

### BRIEF DESCRIPTION OF THE DRAWING FIGURES

FIG. 1 is an architectural view of a communications network supporting enhanced messaging according to an embodiment of the invention.

FIG. 2 is an exemplary screen shot of a user interface of the application (119) of FIG. 1 according to an embodiment of the present invention.

FIG. 3 is a block diagram illustrating a routing system 300 for routing or moving email messages according to one embodiment of the present invention.

FIG. 4 is a block diagram illustrating a pop-up interface for managing contacts and for viewing certain groups defined in a contact list as a tag cloud.

FIG. 5 is a block diagram illustrating component layers of tagging and parsing module that may be adapted to a messaging application.

FIG. 6 is an email application interface illustrating a dashboard style display of information.

FIG. 7 is an exemplary screen shot of a calendar interface invoked by interacting with a calendar button or option.

### DETAILED DESCRIPTION

The inventor provides a messaging application that can be configured to perform automated tasks based on tag word associations created between specific elements of the application. The present invention is described in enabling detail using the various embodiments provided below.

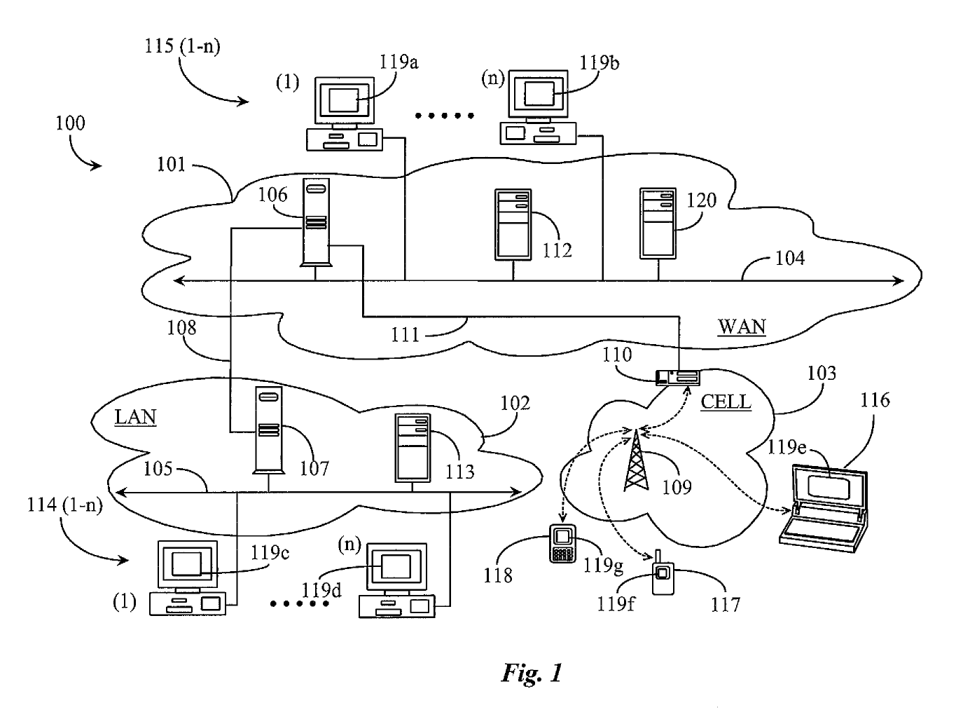

FIG. 1 is an architectural view of a communications network 100 supporting enhanced messaging according to an embodiment of the invention. Communications network 100 includes a wide-area-network (WAN) 101. WAN 101 is the Internet network in one embodiment and is further defined by an Internet backbone 104 that represents all of the lines, equipment and access points that make up the Internet network as a whole. Therefore, there are no geographic limitations to the practice of the present invention.

In one embodiment, WAN 101 is a corporate WAN or a private network like a campus network or Intranet. In a preferred embodiment WAN 101 is the Internet network and will be referred to as Internet 101 in this specification. Communications network 100 also includes exemplary sub-networks local area network (LAN) 102 and cellular (CELL) network 103. LAN 102 may represent an enterprise LAN connected to Internet network 101. LAN 102 is further defined by a LAN backbone 105. Internet 101 includes an IP routing node 106 that has connection by network access line 108 to an IP router 107 within LAN 102. Cell network 103 may be any wireless telephone network. Cell network 103 has connection to Internet backbone 104 via an edge router or network gateway 110, an Internet access line 111 connected to router 106.

Internet 101 may be accessed directly or indirectly through networks like LAN 102 and cell network 103. A messaging server 112 is provided within Internet 101 and is connected to backbone 104. Server 112 may be a POP email server like an Outlook™ or Exchange™ email server. Server 112 may also represent an IMAP server such as for Yahoo™ mail, Google™ mail or another IMAP messaging server. In this example server 112 will be referenced as a POP email server for discussion purposes only.

Email server 112 is a routing point for email and serves email messages to authorized users who access the server to retrieve (download) their email using a desktop email application. In the event that server 112 is an IMAP server, the utility for viewing and saving email is also provided at the server. In this example sever 112 is a POP/SMTP server for incoming and outgoing emails and subscribers have desktop email applications adapted to access the server from endpoint appliances.

Those whom might have access to mail stored for delivery within server 112 include users 115 (1-n). Users 115 (1-n) are visually represented in this example by personal computers (PC) icons. Users 115 (1-n) typically access Internet 101 through a variety of different ways. Many use Internet Service provider (ISP) organizations through a telephone network or a cable modem connection through a cable network. Dialup, broadband, and digital subscriber line (DSL) are all viable methods as is satellite-based Internet access.

LAN backbone 105 supports multiple LAN users 114 (1-n). Users 114 (1-n) represent enterprise-based personnel with Internet access through firewall/router 107 and network IP router 106. It is noted that data packets in a data packet network may take numerous different paths through the network to reach ultimate destinations. IP routers 107 and 106 as well as gateway or bridge router 110 represent logical access points more than actual components as there may be a wide variety of network hardware supporting messaging communication without departing from the spirit and scope of the present invention.

Cell network 103 includes a cellular relay tower 109 that communicates wirelessly to edge router 110 and to a variety of Internet-capable computing appliances representing users 116, 117, and 118 accessing Internet 101 through cell network 103. The appliances represented are a Laptop (user 116), a cell phone (user 117), and a smart phone (user 118). Users 115 (1-n) and 114 (1-n) are represented by PC icons although they to may use any Internet capable appliance that is adapted for messaging.

Each appliance connected to network 101 has a desktop email application (119) installed thereon and executable there from. Email application instances 119 a-g are distributed among user appliances with instances 119 a and b displayed on PC 115 (1) and 115 (n) and instances 119 c and d displayed on PCs 114 (1) and 114 (n). Email application instance 119e is displayed on laptop 116; instance 119f is displayed on cell phone 117, and email application instance 119g is displayed on smart phone 118. Different versions of the email application might be provided for installation on different types of devices as is generally known. The lettering associated with element number 119 is intended only to illustrate different instances of an email application and does not signify differing versions of an email application.

In this example, email messages are stored for download in email message server 112. Each user running an instance of email application (119) on the associated appliance and having an email account with the service hosting server 112 may access server 112 while connected online to download or upload email messages as is typical in the art. In the case of IMAP, each instance of email application (119) is accessed from server 112 while the user is connected online and does not reside on any user appliance. However, any user may integrate an IMAP account with a desktop application so they can use a desktop interface to access and to download IMAP messages.

The inventor provides a way for users to interact with the messaging system represented herein by server 112 and application instances (119 a-g) using created associations between specific elements of the messaging application. As was described with reference to the background section of this specification, email data including folders messages calendar task and contact information may be held in a file known as a PST file or personal folder for each user of an email account. This file is generally stored locally on digital media associated with the user's appliance. In some cases there is more than one PST file for a single user.

Therefore, all of the data required by the local email application to operate correctly with the user's added information is stored in the PST folder. The associations created between email application elements are, in a preferred embodiment, tag-based using a tagging engine (illustrated later in this specification) to apply one or more tag-words or phrases to email application content. In one specific use-case an individual may create one or more specialized email folders and may supply one or more tags (tag words) to each folder. Email messages may then be moved from the inbox and be deposited into these message folders based on subject line parsing, from identification data (username/domain) or content parsing. An individual may also tag contacts in a list of email contacts with one or more tag words or phrases that are similar or identical to tagged mail folders. In this way any email from a tagged contact will be moved into one or more tagged message folders according to tag association between the contact and the folder or folders.

Processes other than message routing that occur during interaction with a messaging system may be enhanced by permitting a user to tag specific application elements associated with the processes. Certain calendar functions, scheduling processes, and task reminder processes can be enhanced by tagging specific elements associated with those processes.

In one embodiment, a tag server and database 120 is provided within Internet 101 and may be adapted to maintain all of the tag word associations created by all subscribers of the messaging system. Tag server 120 may hold tags for online subscribers who have created them to tag specific application elements such as contacts or message folders. Still another tag server 113 is represented within LAN 102 connected to LAN backbone 105.

The use of tag servers may be more appropriate with an IMAP system where most if not all of the data displayed on a user's appliance screen is server-based data. However, tag servers 113 and 120 may also represent centralized social tag banks that store email or message tags given to users by other users. In such an embodiment a message recipient can tag any incoming emails and those tags, uploaded to the tag server can thus be associated with the from identification data (username/domain) of the tagged user. In one case a user may tag another user only if the user reply's to the email message from the user to be tagged. In this case, the tags may include hyperlinks enabling mail recipients to discover more information about a message originator. In any case a user may be able to view the tags of any tagged user who sends them an email message and may tag the user in a reply message in a fashion similar to Folksonomy. Tags may be descriptive tags based on the experience of the recipient in correspondence with a particular user. At the server, tags may be hyperlink enabled to server more information about a user to those viewing tags of the user. More detail about using tags such as tag words or phrases to create associations between message application elements will e provided below.

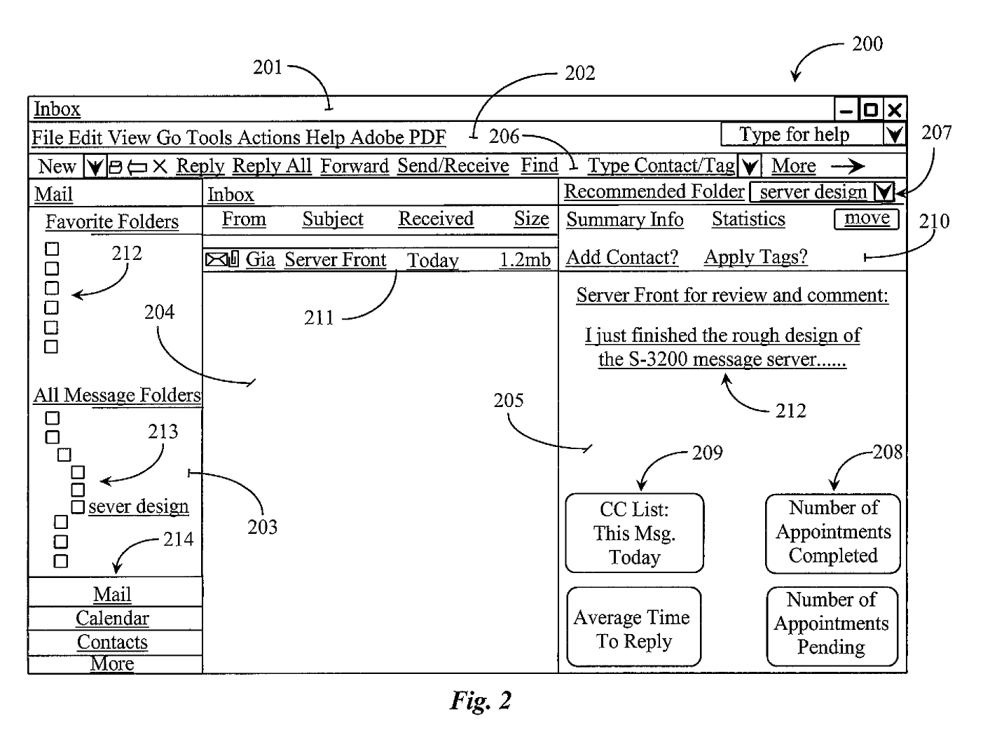

FIG. 2 is an exemplary screen shot of a user interface 200 of application 119 according to an embodiment of the present invention. Interface 200 has a title bar 201 labeled Inbox. A user may minimize, close, or re-size interface 201 by manipulating the control boxes at the far right of the bar as is the case with typical interface screens. Screen 200 also includes a menu bar 202 typical of browser-based email interfaces. Drop-down menu options typical to email interfaces are available like File, Edit, and View and so on including a search input box to access help files. Interface 200 includes a menu bar 206 having menu options typical of an email inbox interface like new message, print, back, and close icons. Typical email menu options Reply, Reply All, Forward, Send/Receive, Find are also typical. In one embodiment email interface 200 is a Microsoft Outlook™ interface enhanced to practice the invention. In another embodiment interface 200 is from MS Exchange™, or another known and existing inbox email interface.

In this example, a search option is provided to the right on menu bar 206 for searching a list of email contacts. A user name or email address may be used as search criteria to find and display a contact from the list. According to an enhancement made possible through the present invention, a user may search the contact list using a tag word or phrase as search criteria. In this embodiment the user has tagged one or more contacts in a list of email contacts and is now able to use those tags to locate and display a target contact without using a username or email address in the search. In one embodiment an additional search enhancement may be provided to enable a user to search through email folders or through all folders for messages using a tag word or tag phrase as search criteria. In one embodiment a same tag word may be used to tag more than one contact creating a loose association of those contacts bound by one or more common tags. These loose associations or groups may be temporary owning to current workflow and communications patterns. Menu bar 206 may include yet more options 207 than are visible in this example.

In this configuration interface 200 has a left navigation pane or window 203. Window 203 may be scrollable in most embodiments and can be adjusted in window space or size relative to the rest of the display. Pane 203 is displaying multiple mail or message folders in an array typical of Outlook™. The top of the pane bears the title Mail followed by a listing 212 of favorite folders. Favorite folders is a simple grouping of most used or most popular mail folders similar to favorite Web sites listed in a browser menu. A user may manually add message folders to a favorites list or they may be automatically added based on some configured rule like the top ten most used folders for example.

Any of the favorite folders may have sub-folders associated thereto that are navigated in hierarchical order according to a typical folder/sub-folder file system. Only the favorite folders are visible in this example. Below the label “favorite” folders 212 pane 203 includes a mapping 213 of all created mail folders organized by a hierarchy typical of a windows folder system. A folder labeled server design is one of three sub-folders in a sub-folder of the second main folder listed. A user may navigate folders and sub-folders in typical fashion by clicking on a main folder to expose the next level of sub-folders.

The display options Calendar and Contacts are provided at the bottom of pane 203 which is open in this case to show Mail in the interface. An option “More” is provided to navigate to additional display options. In this case a center pane or window 204 displays the email main Inbox as is illustrated in title at the top of the window. Window 204 shows all of the unread and read (if configured) email messages in line item list according to some pre-configured message sorting rule or option provided. There are many sort options available with most programs. Inbox pane 204 is scrollable in a preferred embodiment. Only one email message 211 is illustrated in window 204 but there may be many messages in the displayed list. Message 211 has an icon indicating that there is an attachment with the message. It has a “from” field for identifying the sender of the message. Message 211 has a subject field for identifying the subject line of the message. Message 211 has a receive-date field that identifies which day message 211 was sent from the originator. A size field informs the user of the total size of the email message including any or all attachments.

In this case message 211 is from a contact named Gia and has a subject line including the words server and front. The receive date field is configured to make visible only the day but not the time of receipt. In this case the message was received today. The attachment(s) and message size is listed in the size field. More or fewer descriptive fields may be provided as desired.

A message review pane 205 is configured to display to the right of the message inbox pane 204. Review pane 205 enables review of the text body 215 of message 211 without opening the message in its own window. In another embodiment the review pane may be displayed below the inbox pane. In review the full title and message text body 215 is displayed. Window 205 is also scrollable in a preferred embodiment.

One enhancement in this example is that the email application is configured to make recommendations to the user as to where (mail folder) the message (211) should be filed. A recommendation box 207 is provided that displays a recommended folder for the user to move the message to. In this case a folder exists that is tagged server design. It may have more tags that just server design, but server design may be a primary tag that is displayed according to its popularity. In this case the interface includes a content parser that is at least able to parse a subject line of an email message. The recommendation then results from the tag word server that is parsed from the subject line of email 211. The recommendation enable the user to decide if server design will be the containing folder or if some other folder will be the contain folder for the message.

In this example an information summary box 210 is provided that also has a move control feature for moving the email into the recommended folder or into another one by design. Information summary box contains links to gather more information about the email and the contact that originated the email. A summary information link may, when invoked, bring up a second floating window or some other mechanism that contains profile information on Gia including picture and full name. The summary may include any email contact data the user has input into the system for Gia. Statistics collected about the interactions between the user and Gia may be provided through a link to statistics. An available statistic might be the total number of messages received from Gia. Another statistic might by the average size of attachments sent by Gia. Many other stats are possible. Summary information may include profile data from third party sites if authorized such as from LinkedIn™, FaceBook™, or other service providers.

An option for adding a message originator as a contact in a contact list is provided within information box 210. In addition to adding the contact, an option is provided for enabling the user to tag the contact applying one or more tags. In one embodiment the user may tag a contact with one or more tag words or phrases shared by an existing message folder thus creating an association for routing email received from the contact to the folder. In one embodiment a contact may be tagged with tags from more than one mail folder causing replication of the message into those folders when a message is received in the inbox. A tag can be a username a domain name, a group name, or some other contrived tag that makes sense to the user.

In one embodiment a contact may be tagged by other users through the email messages the contact sends to those users in a fashion similar to Folksonomy. The aggregate of tags associated with the username and email domain may be held for access in a third party tag server connected to the primary network such as tag server 120 connected to Internet backbone 104 described further above. In this embodiment when an email message downloads or is otherwise accessible, the receiving user may select a link to view tags created for that message originator. The tags may be descriptive tag words that include hyperlinks to more information about the originator of the message. If a downloaded message is from a contact already in the receiver's contact list and tagged by the receiver, then the receiver of the message may view all of the originator's tags or just the tags created by the receiver of the message. Those tags may also be used locally to route or move the downloaded message to a mail folder sharing the one or more of the tag words.

Message review pane 205 has additional information columns 208 and 209 that are provided and adapted to contain additional statistical data. Column 208 is related to calendar information and gives the user some status information based on an appointment schedule of the user. In this case the information includes, for a specified time window, the number of appointments completed and the number of appointments that are still pending within the time window.

Information that an appointment has been completed, aside from the fact that the scheduled time for the appointment is past, may be augmented by some data input from the user related to a result or some workflow stemming from the appointment interaction. Information 208 may also be provided elsewhere in the interface such as within summary pane 210 or in a display invoked by selecting calendar from navigation options 214. Information column 209 contains the usernames and domains (email addresses) for any persons that were carbon copied (CC) in message 211 by the originator. Another piece of information provided within column 209 is the average time for reply. In this case the receiver of message 211 has emailed the message originator “Gia” and has received reply messages to those emails. The statistic is an average of the reply-time windows. A reply window may be defined as the time passing from the time Gia received a message from the user until the time that Gia sent a reply to that message. These and other statistics may be routinely provided in the Inbox view or in other views available from interface 200.

In one embodiment controls for viewing certain statistics may be provided in a main tool bar provided on the display or in any other tool bar that may be installed to the display. Such statistics may include but are not limited to:
Number of emails today
Number of spam mails today
Number of emails ear marked
Number of unread emails from known sources
Next upcoming appointment

A control might be provided that enables a user to see all the persons responsible for replying to an original message or messages sent by the user, that is to say, view the email reply chain. In one embodiment the persons on an email correspondence thread may be viewed by entering a tag or tags into a search box. Another control may be provided that enable a user to highlight any message from the inbox and display all of the mail folders that contain messages from the originator of the highlighted message.

In one embodiment a feature is provided that enables a user to assemble or display a tag cloud representing a group of contacts or any portion of a list of contacts where the last email received from each contact represented in the cloud is listed in a message view pane.

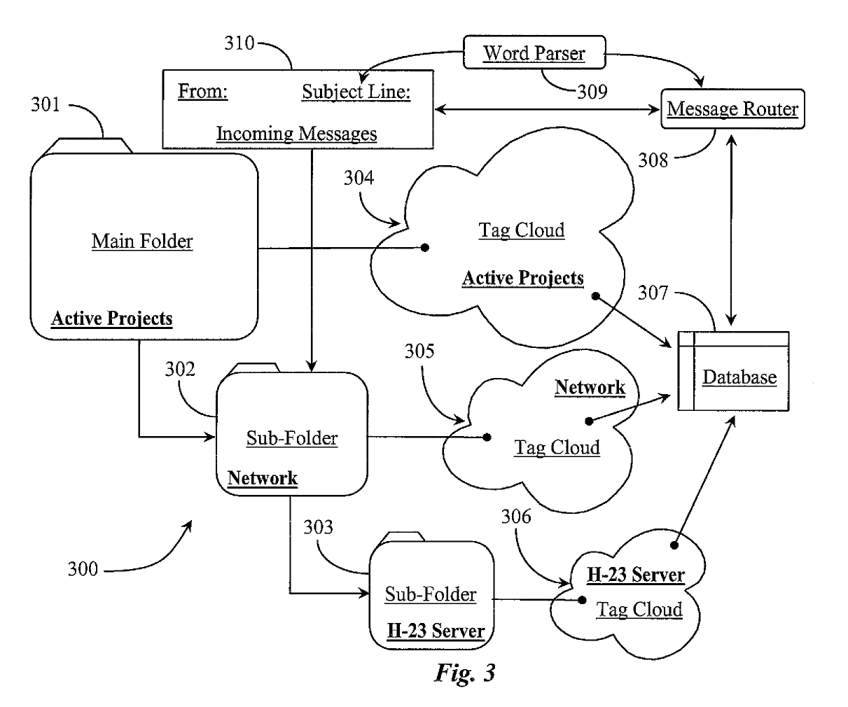

FIG. 3 is a block diagram illustrating a routing system 300 for routing or moving email messages according to one embodiment of the present invention. A main message folder 301 is illustrated and has the primary label or tag Active Projects. A sub-folder 302 is illustrated and associated with main folder 301 and is tagged Network indicating that the folder contains information related to network projects that are currently active. A sub-folder 303 is illustrated and associated with sub-folder 302 further down in the hierarchy and has a tag H-23 Server.

An incoming or downloaded email message 310 may be moved or routed into any one of the related folders depending on a parse of at least the subject line of the message. Email message 310 indicates at least the originator and the subject line. In this case a word parser is provided to parse at least the subject line of an email message. Username or handle and email domain (from) may also be parsed as well. A message router 308 is provided and has direct communication with word parser 309. Message router 308 is adapted to move message 310 into an appropriate mail folder based on a parsed result communicated to the router by the word parser matched against tag words representing mail folders stored in a database 307.

Each folder has one or more tags that can be viewed as a tag cloud. Main folder 301 has a tag cloud 304 that includes the tag active projects and may include other similar or synonymous tags. Sub-folder 302 has a tag cloud 305 that includes the tag network and may include other similar or synonymous tags. Sub-folder 303 has a tag cloud 306 that includes the tag H-23 server and may include other similar or synonymous tags. All of the tags and the folders association mapping may be kept in database 307 and rendered searchable by message router 308.

In this case email message 310 is parsed for subject line by word parser 309. The parser communicates the parsed information to message router 308. Router 308 checks the information against the folder system and tags in an attempt to match the subject line to one or more tags used to describe mail folders. In this case, if the term H-23 server is not in the subject line but the term network projects is in the subject line, then the message may be automatically moved to folder 302 if not to both folders 302 and 301. In one embodiment a replicated message may be treated as a single message in that if one instance is manipulated, the result applies to all of the live instances or copies of the message.

Message router 308 can control cutting and pasting of an email message between folders automatically and without user assistance. In this case email message 310 is deposited into sub-folder 302 tagged Network. If the subject line included the term H-23, then the message would likely have been routed to sub-folder 303 transparently to the user. An alert may be given the user about the routing of a message to ensure that the task was performed to the satisfaction of the user. If the result is ambiguous and it is difficult to determine with certainty which folder should be the folder that contains the message a recommendation may be given to the user by the messaging application. The recommendation may be based upon any information known to the system about the message and the message originator or sender. The recommendation interface may include a check box that requests that in the future just route emails from this sender according to subject line and do not ask for a confirmation.

In another embodiment tags represented in database 307 may include contact tags that were created for contacts in a contact list. In this case the originator of message 310 may share one or more tags with a message folder causing movement of the message into the folder as soon as the message hits the end appliance. Providing more than one tag word or phrase to each folder helps to associate an email message to a folder by providing more flexibility for the subject of the message. A rule may exist for placing a message in the next folder up in a folder hierarchy if all of a folder tag is not matched by the parsed subject line of the message. For example, a subject line that read server maintenance proposal but not H-23, the message may be put in folder 302 network even though the tag network was not found in the subject line. Furthermore, parsing may be performed on the first few lines in the message body as well as in the subject line.

If a message originator is not in a receiver list of contacts then an opportunity to add the email contact information and to apply one or more tags for the new contact might be undertaken. In this process a folder option for creating a new folder may also be presented. For example, a new project may just be setting up with new people that are not yet known to the user. Therefore the user may not as yet define the email collaborators on the project and has no contact information on them or tags created for them. A folder for the new project may not yet exist. However, when a first mail relative to the new project is downloaded, a recommendation engine (not illustrated) may be active and may prompt the user to add the contact, tag the content, and to create a folder for storing messages related to the new project. The folder may be tagged with one or more descriptive tag words. Content parsing or tag association between contact and folder may be used to determine end routing of the message and of other messages that will be forthcoming.

If a first contact has a company domain and the user knows that all of the other emails that will be received about the new project will originate from the same domain then the domain may be used to pre-group contacts once they are identified. For example, @ serversonics.com may be the domain of a company whose personnel are approved to collaborate on the H-23 server project (folder 303). A rule that causes the messaging application contact interface to automatically group all new contacts having that original domain in their email addresses may be set up by the user. In this way all emails are routed to the appropriate folder and if from new originators saved as contacts in the group expressed by the domain name.

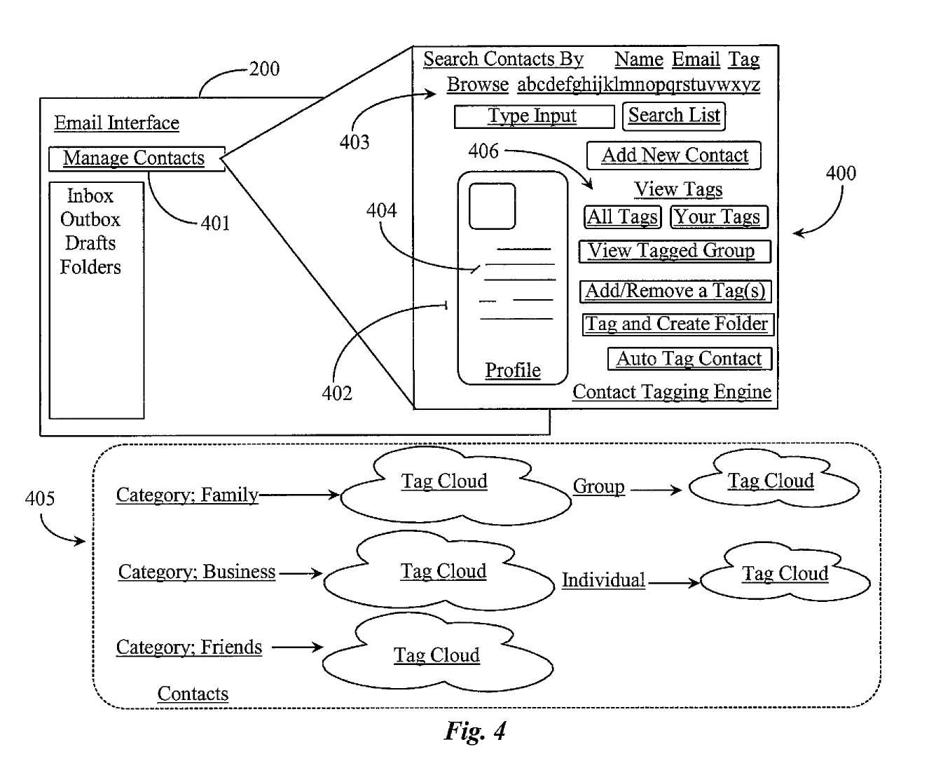

FIG. 4 is a block diagram illustrating a pop-up interface 400 for managing contacts and for viewing certain groups defined in a contact list as a tag cloud. Interface 400 may display as a result of interacting with a manage contacts option 401 accessible through interface 200. Interface 400 may include a footprint 402 that is large enough in display to accommodate one or more search options 403. Search option 403 may enable a user to search contacts by entering a name, email address, or by tag. A browse option using an alphabetical map may also be provided. An input field may be provided along with a search button for searching the list based on the entered criterion.

Interface 400 may include several tag and tag management options 406. Options 406 may include tag view options for viewing all tags or user-created tags (your tags) for any contact. An option for viewing a tagged group may be provided as well as an option for viewing all of the tags in a group. Options 406 include one for adding and removing tags and one for tagging and creating a folder. Another option 406 is one for auto tagging without user involvement. Such options can be ordered and scheduled.

In one embodiment a link is provided in interface 400 for enabling execution of a content tagging engine by the user wherein the contact tagging engine has its own unique interface aside from interface 200. In another embodiment the tagging interface is a plug-in to the email or messaging application and may be executed from within the application to manually tag elements of the email application like folders and contacts. When a contact is located in the contact list by conducting a search, a contact profile box or window 404 may be provided. Profile 404 may include a picture, contact information, work related information, and so on.

Block 405 illustrates application of tag clouds for a group or category of contacts assembled by the user or automatically by the application. For example, the category Family may be represented by a tag cloud having all of the tags of at least the primary tags of the individual family members included therein. By viewing the tag cloud for family, one may be able to discern which family member sends the most emails or is the most emailed of the family members. Other criteria may also be applied to enable discernment and separation of one family member over the others. Such discernment is observed, of course, in the evolution of the font characteristics and or appearance of the tag itself as compared to the other tags in the cloud. A tag view may include the options of viewing a tag cloud or a list of tags.

The category business may be represented by a tag cloud including all of the primary tags of the individual business contacts in the contact list. The same can be said of the categories Friends. A group of contacts may be represented by a tag cloud. An individual contact may also be represented by a tag cloud including more than one tag given to the contact. A group may be a loosely associated bunch of contacts that share a common tag that would suggest a common affiliation or interest shared among the contacts. An example might be applying the tag association member to every contact in the list who belongs to a specific association. An individual may have more than one tag but may exhibit a primary tag as it is born out over time that the contact is most often associated with one tag through searching, routing, or other activity.

It is noted herein that contacts in a contact list may simply be associated to folders having names by rule instead of by tagging, but may still have one or more tags for other purposes like grouping or searching. In another embodiment a contact may have many tags applied to the contact by users tagging email messages received from the contact. These tags may be stored in a central network location by a third party that manages the tags. From a social aspect then, when a user receives an email from an unknown source, the user may view the originators tags associated with that email identity to determine whether the originator may be interesting to the user.

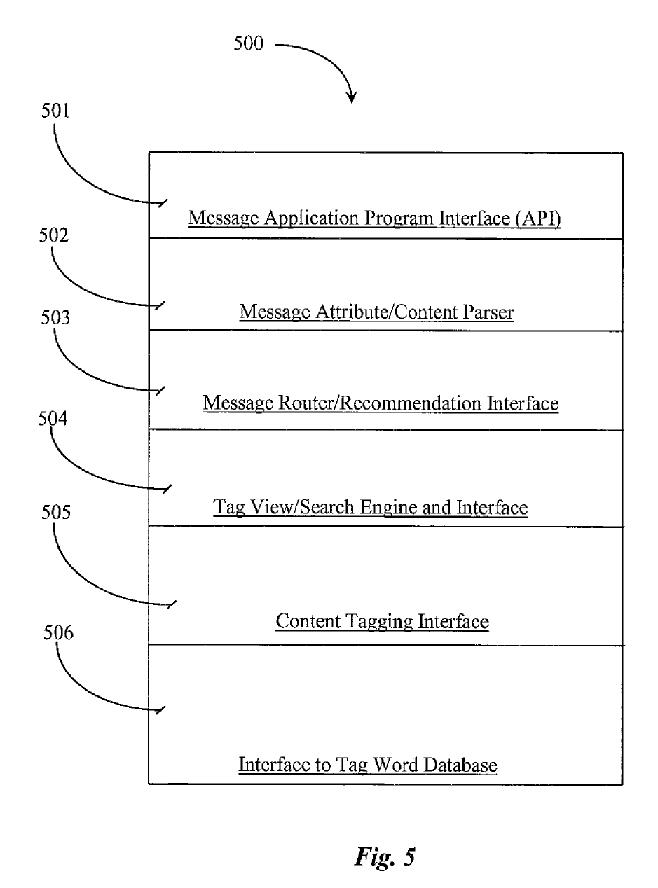

FIG. 5 is a block diagram illustrating component layers of tagging and parsing module 500 that may be adapted to a messaging application. Module 500 may be thought of as a tagging utility that includes search and routing capabilities. Module 500 may be provides as a plug-in installation that is executable from within an affected application. Module 500 includes a message application program interface 501 for managing integration of the parsing, tagging, and specialized search functions provided by the module to options and services available in the messaging application. In one embodiment the tagging utility is adapted to crawl through a user's personal folder or (PST) file and to tag and create folders for depositing email into. This operation may be performed first upon installation of the plug-in. Subsequent executions of this process are electable.

A message attribute and content parser 502 is provided as part of module 500 and provides the ability to parse message attributes (username/domain), message subject line, and in some cases message body content to the messaging application. This capability can be configured to automatically parse messages in the inbox to determine which mail folders will be recommended for deposit of the message. In one embodiment a user reads messages before a routing recommendation is presented to the user. In another embodiment the routing is automatic and occurs immediately after download of messages.

A message router recommendation interface 503 is provided to enable user interaction relative to endpoint routing of email messages. A tag view/search engine and interface component 504 is provided to enhance the email applications search function for contacts and provides the ability to represent elements as tag clouds or tag lists. A content tagging engine and interface 505 is provided that enables a user to manually tag elements of a messaging application like folders and contacts. The tagging engine and interface are executable from within the email application.

Module 500 includes an interface to a tag word database that may contain all of the tags a user has created relative to the email application the module plugs into. The tag word database maintains all of the tags and associations inferred by the tagging operations. The tag word database may be supported by any digital media accessible to the appliance hosting the messaging application and plug-in. In one embodiment, a single plug-in may contain sufficient features to support more than one email or messaging application.

In one embodiment, module 500 is installable to an existing messaging application like Outlook™, for example, and provides all of the required tool bars and controls for executing and managing the progress of available features provided by the module. Other components may also be included within module 500 without departing from the spirit and scope of the invention such as algorithms for providing statistical calculations relative to messages, folders, contacts, appointments, and so on.

In one embodiment the features and functions enabled by module 500 are bundled in with a proprietary email application that can be used as a desktop application. In another embodiment where a server manages all user data in an IMAP scenario the features and functions may be provided with the server-based email program and are generally available to all of the subscribers.

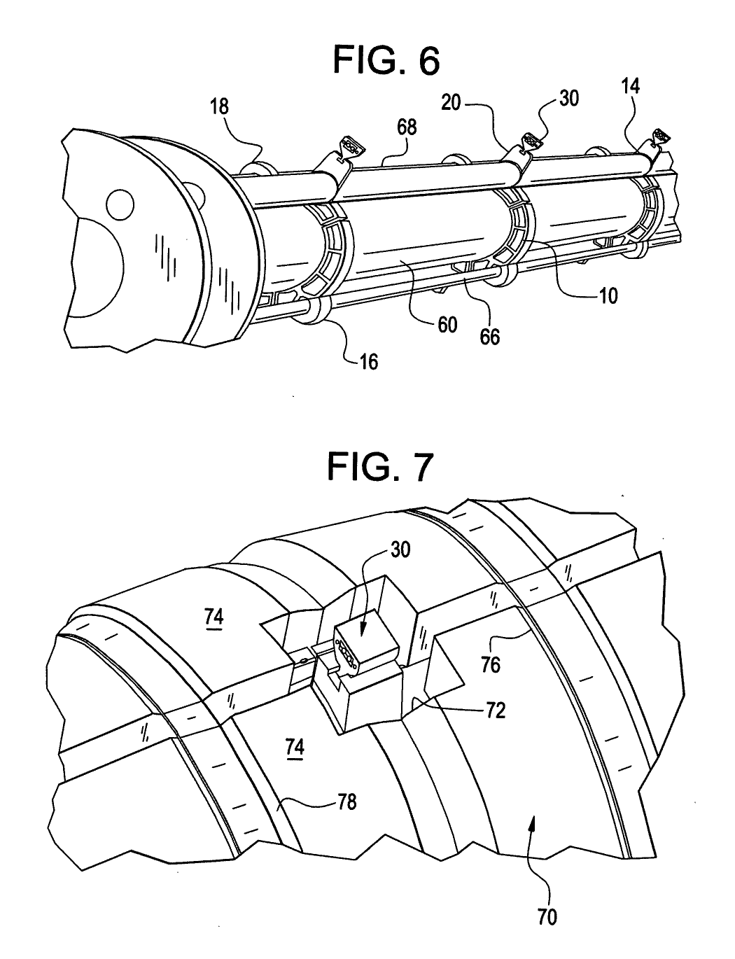

FIG. 6 is an email application interface 600 illustrating a dashboard style display of information. Interface 600 has a message view window 601 that provides a summary of unread messages that have been downloaded to the user's application. Window 601 is scrollable in a preferred embodiment. Interface 600 may be configured to display a general tag cloud 602 or tag list if so desired that includes all of the tags that saw action over a specified period of time, in this case, for the current day. The cloud or list may be configured for an hour, or for some smaller or greater period than one day. The tags may be a mixed bag including tags for contacts, messages, folders, appointments, calendar days, etc.

Interface 600 includes a message search interface 603 where a user may search messages by tag. Specific folders may be searched or all messages in all folders may be searched. Other conditions may also be configured into the search such as search only unread messages. Interface 600 includes an interactive scale 604 for measuring the level of business of a user for any given period of time. A level of business for a user may be calculated based on number of appointments, number of emails to be processed by the user, or some other workflow related criteria. In this case busyness levels for a day, a week, and a month, are provided by default. A user simply enters the date in one or more of the option date fields and invokes the check button to retrieve the information. The level may be expressed as a colored bar graph or some other graphic that marks a specified level. A user may create a busyness level scale such as between 1 and 5 with 1 being not busy and 5 being very busy and then represent the scale as a bar colored to the level of business. In another embodiment an indicator may be provided that shows a color such as green for a low level, yellow for a median level, and red for a higher level. The user may be enabled to define the weight relative to what actually constitutes busy and the criterion used to determine the weight. Such a feature may be useful in enabling the user to plan commitments more efficiently by spreading them out over time to mitigate low and high levels of busyness.

Interface 600 has a link button 605 to a calendar feature of the email application. Invoking link 605 opens a calendar interface. Busyness levels may also be annotated over a calendar week view or month view. Interface 600 includes an email deposit summary section 606. In this example, the deposit summary lists all of the emails that have been deposited in folders today. The interface is switched to Folder view by default and shows a main folder or work folder with the total emails 15. Under work there is a folder for sales, a folder for new products, and a folder for internal communications. All of the 15 emails are deposited into sub-folders of main folder work. There are 5 email messages in the folder sale leads. There are 3 email messages in the folder new products. There are 7 email messages in the folder internal communications. Summary interface 606 shows the total number of unread messages under the category work and the number of the total deposited under each sub-category of work. Other hierarchies may be observed without departing from the spirit and scope of the invention.

Message view 601 shows the message line information for the 15 email messages in each of the folders. Under the folder sales leads there are assumed 5 messages only 3 of which are illustrated for discussion purposes. Under New it may be assumed there are 3 line items and under Internal it may be assumed that there are 7 line items. Tag cloud 602 may contain the primary tags associated with the “from” identities of the 15 messages. Clicking on a tag of a contact like Jim or Jane, for example may invoke the opening of a message that is yet unread in a mail folder.

Interface 600 may be configured to display a number of different information blocks or sections in a number of different ways. In one embodiment a user may clear tag cloud 602 by answering or at least reading all of the messages represented in the cloud, or just by invoking a clear option. The cloud may build again in real time as new activity occurs like deposit of a new message. The user may quickly recognize a tag just appearing in the cloud as one that has high priority at the time thereby serving as adequate notification that a high priority message has just been downloaded to an inbox or other folder from the message server. Other appearing tags may not carry as high of a priority in the mind of the user at that time indicating arrival of messages that at the time are not important. Those tags may be ignored or eventually cleared from the cloud. Tag cloud 602 may be tied strictly to incoming messages and can be made to take up the entire footprint of the interface. The cloud may also be configured to make a sound when a new tag appears in the interface.

FIG. 7 is an exemplary screen shot of a calendar interface 700 invoked by interacting with a calendar button or option. In this case interface 700 is setup to display a number of items in a display window 701 similar to a summary or dashboard interface that may be configured or personalized by a user to display only desired items in display modes selected by the user.

A calendar week view 702 is illustrated that shows the days ordered by a user by inputting a beginning date. The system provides the additional 6 days from the beginning date entered. In this case the view shows Sun through the following Saturday. Appointments on certain days of the week are indicated. An arrow illustrates where in current time frame the week is. The current time frame is Wednesday morning meaning that at the time of display it is early Wednesday.

A tag cloud 705 is illustrated and includes the tags representing the same days of the same week illustrated in the calendar view 702. The tags Tuesday, Wednesday, and Thursday are enlarged to show the importance of those days having appointments that must be met. The tag Wednesday is just larger in font size than and Tuesday and Thursday indicating a slightly higher importance level for the activities slated for Wednesday. A user may weight importance levels based on workflow priority considerations. Tag cloud 705 and calendar view 702 may be set up to show periods shorter or longer than a week. The tags in cloud 705 may represent days, weeks, months, or other defined periods. Although not specifically illustrated in this example, a tag cloud for scheduled appointments may be provided wherein the tags included in the cloud represent those scheduled appointments.

Display window 701 includes a snapshot slider bar adapted to identify and retrieve a historical snapshot of the interface and displayed activity. A snapshot in time report may span a day, a week, or a larger period. A data storage facility may be provided that is accessible to the interface and snapshot utility so that the correct information may be displayed as it was during the period in history. A slider is provided to enable a user to easily go back in increments of time to cause another display of the interface that is appropriate for the time point indicated. Time may be represented in slices and a report spanning a larger period of time would contain multiple time-point snapshots or slices assembled sequentially for review. A summary information block 704 is provided in window 701 and indicates the number of appointments completed and the number of appointments pending for the week illustrated in calendar view 702.

The indication of appointments completed may require more data than the fact that the appointment times have past as indicated by the arrow. An appointment can be missed or rescheduled. The indication of complete for an appointment may depend on some result of the meeting that is entered into the user's system during or after the appointment.

In this example a tag cloud 707 is provided that includes tags representing tasks that must be completed before upcoming appointments are conducted. An interactive button 711 labeled view related tasks enables the user to view in detail any requirements associated with any pending appointment. In the tag cloud, the user may readily see that a PowerPoint™ sales presentation (PPT._Sales) is required and is a priority, perhaps because of the lead time needed to prepare the document correctly. By clicking on the tag, the user may see the additional information such as which meeting the presentation is required for and any additional information about the meeting. Perhaps the meeting on Thursday is a sales meeting and the user is required to present at the meeting. Other task tags include prepare contract, read spec, and prepare spread sheet on a marketing plan (SP Sheet_MP).

A tag cloud 706 is illustrated in this example within window 701 and includes a tag view of target contacts associated with the appointments for the week illustrated. Interacting with any one of the tags may cause additional information like contact information and the associated meeting information and scheduling data. Another tag cloud 710 is provided within display window 701 and includes folder tags of folders containing unread messages associated with the pending appointments on the calendar for the week. The presence of a folder tag here indicates at least one message relative to a contact involved with a meeting is residing in the folder.

The larger the font for a tag, the more messages the folder contains from contacts involved in one or more of the scheduled meetings or appointments. The tags are also topical of the themes or goals of the appointments or meetings. For example, the tag “Sales” may represent a folder topical to a planned sales meeting on “Thursday” (calendar day tag) at which the Power Point presentation (task tag) will be made to employees of a company with the email domain sales.com. New messages in the sales folder may be requests related to this pending presentation. In this calendar interface all of the tag clouds are related to the appointment schedule of the user in a specific way and the tags within the clouds may be interacted with to glean more information and the correct associations between the tags.

It will be apparent to one with skill in the art that the tagging and parsing system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A messaging application comprising:
a user interface executable from a digital media on a computing system onboard or accessible to a computing appliance, the user interface enabling display and access to one or more message folders, a list of contacts, a calendar, and a message generation template; and
a word tagging utility installed to and executable from the digital media and made accessible through the user interface;
characterized in that the word tagging utility is operable to tag functional elements of the message application to create associations between the tagged elements, the associations recognized by the messaging application in the performance of tasks involving the elements.

2. The messaging application of claim 1 wherein the user interface is an email interface and the computing system is a memory drive integral to the computing appliance.

3. The messaging system of claim 1 wherein the user interface is an email interface and the computing system is a server with a digital medium accessible to the computing appliance over a data network.

4. The system of claim 3 wherein the data network is the Internet network.

5. The messaging application of claim 1 wherein the functional elements subject to tagging include at least message folders and contacts.

6. The messaging application of claim 5 wherein the functional elements subject to tagging further include scheduled appointments and related tasks pending.

7. A tagging system comprising:
a tagging utility executable from a digital storage system onboard or accessible to a computing appliance, the tagging utility having a user data input interface and a target selection interface;
a database for storing tag words and for mapping associations between tagged elements; and
an application program interface to a messaging application;
characterized in that the targets subject to tagging are functional elements stored by or made part of the messaging application and the act of tagging such elements causes the application to, based on the tag associations created, perform specific tasks relative to the tagged elements and associations created.

8. The tagging system of claim 7 wherein the messaging application is an email application and the storage system is a memory drive integral to the computing appliance.

9. The tagging system of claim 7 wherein the messaging application is an email application and the storage system is a server with a digital medium accessible to the computing appliance over a data network.

10. The tagging system of claim 7 wherein one of the specific tasks is routing email messages based on tag associations between from identities and message folders.

11. A method for routing electronic messages comprising the steps:
(a) using a tagging utility, tagging one or more individual contacts with one or more tags;
(b) tagging one or more existing or created message folders based in part on the tagging operation of step (a) defining associations between the contacts of step (a) and the message folders by one or more common tags;
(c) receiving an electronic message from one or more of the contacts the message including a subject line and a from identity; and
(d) routing the electronic message to the one or more message folders based on the associations defined by the tagging operation.

12. The method of claim 11 wherein the messages are email messages and the message sorting is performed by an email application.

13. The method of claim 11 wherein in step (a) the tagging utility is executable through a control on a toolbar of a messaging application interface.

14. The method of claim 11 wherein at step (d) the routing is performed after the message is read by a user, the final destination for routing dependent upon user acceptance or rejection of a folder recommendation.

15. The method of claim 11 wherein in step (d) the routing is performed immediately after a message has arrived and before it is accessed by a user.

16. The method of claim 11 wherein steps (a) and (b) are performed automatically a first time by crawling through a personal folder containing one or more folders and a list of contacts.

17. A method for routing electronic messages comprising the steps:
(a) using a tagging utility, tagging one or more existing or created message folders defining associations between messaging contacts of a contact list and the message folders;
(b) receiving an electronic message from one or more of the contacts the message including a subject line and a from identity; and
(c) routing the electronic message to the one or more message folders based on parsing the subject line of the message and matching that to the tags for one or more message folders.

18. The method of claim 17 wherein in step (b) one or more parts of the identity of the message originator are used to define the association to an existing or created folder also tagged with one or more parts of the identity.
